(19) United States
(12) Patent Application Publication
(10) Pub. No.: US 2019/0005423 A1
(43) Pub. Date: Jan. 3, 2019

(54) CALCULATION AND VISUALIZATION OF SECURITY RISKS IN ENTERPRISE THREAT DETECTION

(71) Applicant: SAP SE, Walldorf (DE)

(72) Inventors: Eugen Pritzkau, Wiesloch (DE); Wei-Guo Peng, Dallau (DE); Thomas Kunz, Lobbach/Lobenfeld (DE); Hartwig Seifert, Elchesheim-Illingen (DE); Lin Luo, Wiesloch (DE); Marco Rodeck, Maikammer (DE); Rita Merkel, Ilvesheim (DE); Hristina Dinkova, Nussloch (DE); Florian Chrosziel, St. Leon-Rot (DE); Nan Zhang, Schriesheim (DE); Harish Mehta, Wiesenbach (DE)

(21) Appl. No.: 15/639,863

(22) Filed: Jun. 30, 2017

(51) Int. Cl. G06Q 10/06; G06N 5/02

(52) U.S. Cl. CPC G06Q 10/0635; G06N 5/022

(57) ABSTRACT

An information technology computing landscape is divided up into hierarchically-dependent components. Relevant risk factors are identified for each component and the identified relevant risk factors are separated for each component into static and dynamic risk factor groups. The weight of each risk factor is determined in the static and dynamic risk factor groups for each component. Static and dynamic security risks are calculated for each component.

### CROSS REFERENCE TO RELATED APPLICATIONS

This application is related to and filed in conjunction with U.S. patent application Ser. No. ______, filed on Jun. 30, 2017, entitled “REAL-TIME EVALUATION OF IMPACT-AND STATE-OF-COMPROMISE DUE TO VULNERABILITIES DESCRIBED IN ENTERPRISE THREAT DETECTION SECURITY NOTES”, the entire contents of which are hereby incorporated by reference.

### BACKGROUND

Enterprise threat detection (ETD) typically collects and stores a large amount/large sets of log data associated with various systems (often referred to as “big data”) associated with an enterprise computing system. The stored data can be analyzed computationally using forensic-type data analysis tools to identify security risks in revealed patterns, trends, interactions, and associations, especially relating to ETD behavior. Appropriate responses can then be taken if anomalous behavior is suspected or identified. Given the amount/size of the stored data and possible multiple attributes or dimensions the stored data, it can be difficult for a user to determine relevant data (or, conversely, filter out unrelated data) when attempting to evaluate an impact of and present an evaluation for a security risk.

### SUMMARY

The present disclosure describes calculation and visualization of security risks in enterprise threat detection (ETD).

In an implementation, an information technology computing landscape is divided up into hierarchically-dependent components. Relevant risk factors are identified for each component and the identified relevant risk factors are separated for each component into static and dynamic risk factor groups. The weight of each risk factor is determined in the static and dynamic risk factor groups for each component. Static and dynamic security risks are calculated for each component.

The previously described implementation is implementable using a computer-implemented method; a non-transitory, computer-readable medium storing computer-readable instructions to perform the computer-implemented method; and a computer-implemented system comprising a computer memory interoperably coupled with a hardware processor configured to perform the computer-implemented method/the instructions stored on the non-transitory, computer-readable medium.

The subject matter described in this specification can be implemented in particular implementations, so as to realize one or more of the following advantages. First, the described methodology and visualizations provide a quick overview of both static and dynamic security risks associated with hierarchically-arranged components of an information technology (IT) landscape. Second, the described methodology and visualizations provide a quick overview of different aggregation levels of the components. Third, a drill-down into lower-levels of the components can be performed. Fourth, sorting or filtering of the components can be performed a hierarchically ascending or descending manner. Filtering can be performed by available attributes (for example, priority level, computing system name, and computing system role). Fifth, the described methodology and visualization provides a basis for prioritization of countermeasures for any perceived security risks. Other advantages will be apparent to those of ordinary skill in the art.

The details of one or more implementations of the subject matter of this specification are set forth in the accompanying drawings and the description. Other features, aspects, and advantages of the subject matter will become apparent from the description, the drawings, and the claims.

### DESCRIPTION OF DRAWINGS

FIG. 1 is a block diagram illustrating division of a component into static and dynamic states in a graphical user interface (GUI), according to an implementation.

FIG. 2 is a block diagram illustrating division of a component into sub-components, according to an implementation.

FIG. 3 is a flowchart illustrating an example method for calculation and visualization of security risks in enterprise threat detection (ETD), according to an implementation.

FIG. 4 is a block diagram illustrating an example computer system used to provide computational functionalities associated with described algorithms, methods, functions, processes, flows, and procedures as described in the instant disclosure, according to an implementation.

Like reference numbers and designations in the various drawings indicate like elements.

### DETAILED DESCRIPTION

The following detailed description describes calculation and visualization of security risks in enterprise threat detection (ETD), and is presented to enable any person skilled in the art to make and use the disclosed subject matter in the context of one or more particular implementations. Various modifications, alterations, and permutations of the disclosed implementations can be made and will be readily apparent to those or ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

ETD typically collects and stores a large amount/large sets of log data associated with various systems (often referred to as “big data”) associated with an enterprise computing system. The stored data can be analyzed computationally using forensic-type data analysis tools to identify security risks in revealed patterns, trends, interactions, and associations, especially those relating to ETD behavior. Appropriate responses can then be taken if anomalous behavior is suspected or identified.

There are many factors that can directly or indirectly cause a security risk. Given the amount/size of the stored data and possible multiple attributes or dimensions the stored data, it can be difficult for a user to determine relevant factors in (or, conversely, filter out unrelated factors from) the ETD data when attempting to evaluate an impact of, and presenting an evaluation for, a particular security risk. As a result, evaluation of a security risk in objective way is difficult.

To provide reliable risk evaluation, as many security influence (risk) factors as possible should be taken into account (for example, risk factors based on big data whose processing is extremely time and machine power consumable. Separation of the risk factors into dynamic and static factors and then further real-time calculation of the dynamic factors, makes risk calculations much more doable.

The result of an evaluation for a security risk should be presented in a graphical user interface (GUI), in as a transparent and explainable manner as possible. If not, it is easy for ETD users to lose perspective of, fail to respond to, or to respond to the security risk in a less-than-optimum manner. In typical implementations, the described methodology presents a GUI visualization of security risks based on two columns (that is, static and dynamic), each presenting a separate risk evaluation in percentage values. The visualization enhances understanding of security risk values.

At a high-level, to evaluate a security risk in an information technology (IT) computing landscape (for example, associated with a particular educational, governmental, or business entity), the IT computing landscape is divided and further subdivided into hierarchically-dependent components. The division can be performed in a stepwise manner, considering hierarchical dependency of components, until basic components depending from non-basic components are determined at a granularity that cannot be (meaningfully) divided further into lower-level sub-components of the basic components.

Division is performed into components with risk properties including: 1) assignment of a security rating; 2) seen as a target for an attack; or 3) seen as a unit with a potential for security improvement. Once a component cannot be seen as an aggregation of components with at least one of the risk properties above, the component is considered to be at the lowest level possible. For example, a lowest-level component could be a software component running on a server. Moving up the hierarchy, multiple software components on a server could be aggregated to the server, multiple servers could be aggregated to a system, and multiple systems could be aggregated to a system landscape. As another example, a top-level (that is, a highest hierarchical level) component could represent a particular educational entity, sub-components (for example, mid-level) could represent various campuses or departments that make up the educational entity, and lowest-level sub-components could represent various classrooms or instructors associated with the campuses or instructors, respectively.

Sorting or filtering of the components can be performed in a hierarchically ascending or descending manner. Filtering can be also be performed by available attributes (for example, priority level, computing system name, and computing system role).

Each non-basic and basic component is characterized over a static and dynamic state. In some implementations, stable factors (for example, that a system is a productive system) contribute to a component's static risk. Component static risk can be performed with background computing processes (for example, not in real-time), as factors used in calculating the static risk seldom change. For example, a static risk factor might include that a particular system in an IT computing landscape is a productive system containing highly sensitive financial data. In contrast, dynamic risk factors are those, that change in real-time (or substantially real-time) and for which evaluation should be done in real-time (or as close to real time as possible) as the dynamic risk factors can continuously change. For example, dynamic risk factors can include publication of a security patch for an operating system or software application or available data on current knowledge/exploitation of an existing security leak.

The separation of the static and dynamic risk factors into dynamic and static risk factor groups is important from a computational standpoint. Evaluation of each factor based on big data (typically static risk factors) can require time- and processor-intensive processing. Dividing the risk factors into static and dynamic risk factors can all saving computing resources for risk factor calculation.

In some implementations, the separation of the risk factors into dynamic and static risk factor groups can be done automatically based on metadata describing each identified risk factor. Additionally, in some implementations, the separation or verification/calibration of the separation of the risk factors can be performed by machine learning technologies. For example, the machine learning technologies can operate on available metadata to separate identified risk factors into dynamic and static risk factors. Provided input can refine the efficiency/correctness of separation performed by the machine learning technologies and to update the metadata or other data used to describe each identified risk factor, groups of risk factors, and other data.

In the simplest case, security risk is the product of the probability of the occurrence of an accident and the loss in case of the accident. In ETD, a static indicator is the expected loss based on importance of a component with respect to confidentiality, integrity, and availability. A dynamic indicator is the probability of an attack based on the latest usage of vulnerable functionality. Separation of the static/dynamic indication into separate values is desired as it provides a security expert a strong basis to prioritize countermeasures. In some implementations, “static” and “dynamic” aspects can be generalized. For example, risk averaged over a year could be considered a static value and the risk averaged over an immediately preceding day as a dynamic value.

For both static and dynamic states, a risk is typically valued as a percentage value (for example, 0—no risk, 100—definite risk), but could be set as any value to distinguish a difference between levels of risk. Calculation of the static and dynamic states of non-basic components is performed over an aggregation of the states of its associated basic components.

In some implementations, in order to prevent the loss of single high values, a mean or median calculation/value is not used. Instead, an aggregation formula rates a maximum value (for example, between 90 and 92 percent) and an average value (for example, between 8 and 10 percent), depending on a standard deviation. In some implementations, an example aggregation formula can be provided by Equation (1):

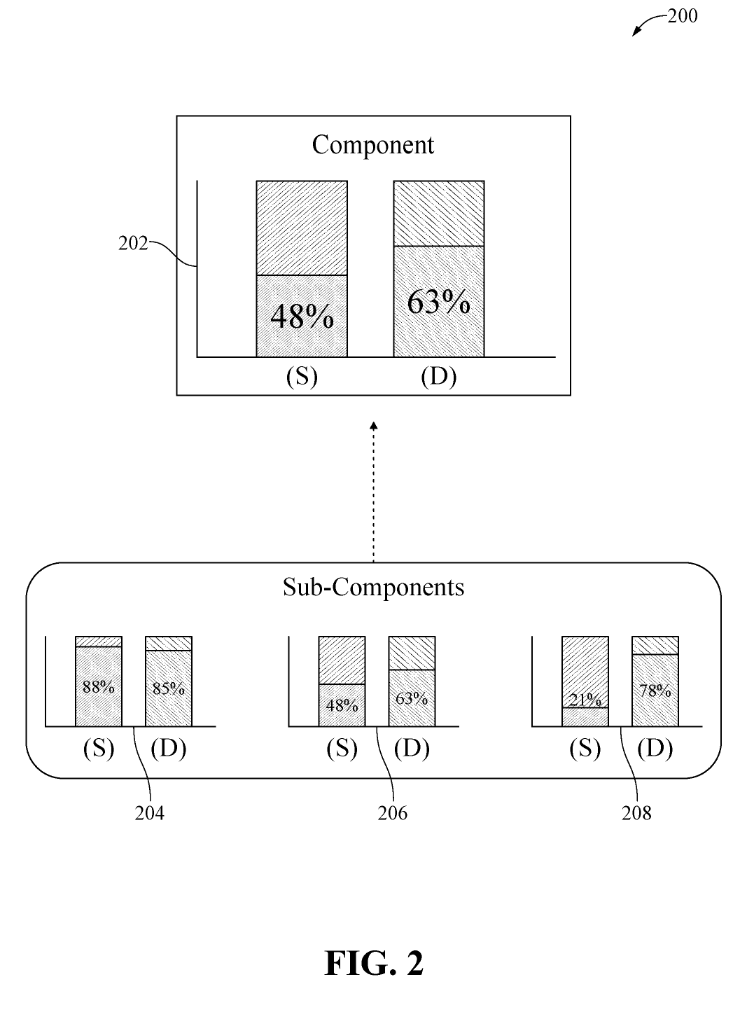

For a set X={x1,x2, . . . ,xn}: a(X)=max(X)*((90+2*stddev(X)/70.71)+avg(X)*(10−2*stddev(X)/70.71))/100 (1),

where X is a set of static risk values for components and sub-components (for example, sub-components 204, 206, and 208 and component 202 in FIG. 2). The static risk value of a component (here, 202) given its associated sub-components (here, 204, 206, and 208) would then be calculated using a(X).

With a set of objects and a normalized (risk) value assigned for each object, a simple way to obtain a normalized assembled (risk) value for the set of objects is to use a mean or median value. But mean or median values have the disadvantage that single high values can be lost.

The desire for the described methodology is for an assembled (risk) value to have two characteristics: 1) Raising awareness if there are single sub-components with high risk value, and 2) Nevertheless, do not ignore the risk values of other sub-components. Accordingly, Equation (1) rates the maximum value between 90 and 92 percent and the average value between 8 and 10 percent, depending on standard deviation. Maximum standard deviation for a set of values between 0 and 100 is (50*square root of 2)=70.71. 90 and 10 are the weights for the maximum resp. the mean value if the standard deviation is minimal (=0). 90+2 and 10−2 are weights for the maximum resp. the mean value if the standard deviation is maximal (=70.71).

For example, if:

X1: 90, 50, 50, 50, 50, 10, 10, 10, 10→a(X1)=85,09, and

X2: 90, 30, 30, 30, 30, 30, 30, 30, 30→a(X2)=84.97.

Although maximum and mean value are identical for X1 and X2, the calculated risk value for X1 is higher than the calculated risk value for X2, as the standard deviation is higher.

As will be appreciated by those of ordinary skill in the art, Equation (1) is one possible implementation of an aggregation formula. Other formulas and values consistent with this disclosure are also considered to be within the scope of this disclosure.

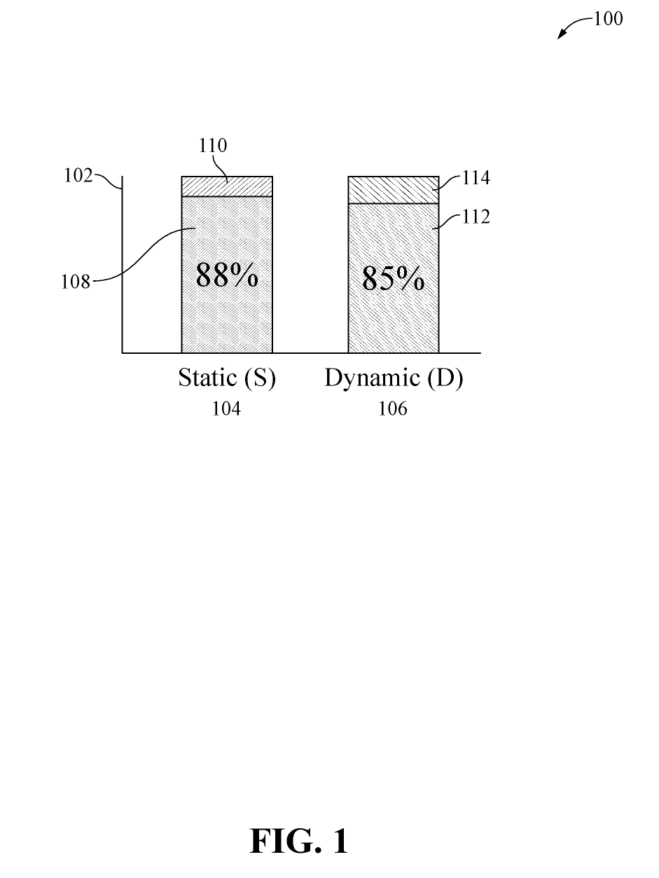

FIG. 1 is a block diagram 100 illustrating division of a component into static and dynamic states in a GUI, according to an implementation. Illustrated component 102 is divided into a static (S) indicator 104 and a dynamic (D) indicator 106 for a static and dynamic state, respectively. Each of the static indicator 104 and the dynamic indicator 106 is associated with a risk value. For example, static indicator 104 has an illustrated risk value of 88% and the dynamic indicator 106 has an illustrated risk value of 85%. Note that, in some implementation, an indication of “not applicable” (or similar) can be used when a value cannot be calculated (for example, when a system is not assessed with respect to confidentiality, integrity, availability, or when the usage or vulnerable functionality cannot be determined).

As illustrated in FIG. 1, a first color 108 (for example, dark blue) can be used for a portion of the static value indicator column from 0 to the static value (here 88%), while a second color 110 (for example, light blue) can be used from the static value to 100. Similarly, a third color 112 (for example, red) can be used for a portion of the dynamic value indicator column from 0 to the dynamic value (here 85%), while a fourth color 114 (for example, green) can be used from the dynamic value to 100. A fifth color (for example, gray) that is different from the first, second, third, or fourth colors can be used in the case of “not applicable” for both indicator columns. Note that the presence of labels “Static (S)”/“Dynamic (D)” or “(S)”/“(D)” in the figures is primarily for understanding of the described subject matter. While some GUI interface implementations can include these labels, typically these labels are not present in the GUI interfaces.

FIG. 2 is a block diagram 200 illustrating division of a component into sub-components, according to an implementation. Component 202 is divided into sub-components 204, 206, and 208. Both component 202 and sub-components 204, 206, and 208 are also associated with static and dynamic states as described in FIG. 1. Although not illustrated, the described methodology and visualization allows for greater than two levels of components.

The security risk of component 202 is calculated over an aggregation of sub-components 204, 206, and 208. As FIG. 2 illustrates, aggregations of components at the same or different levels can be visualized and a user can drill-down into lower hierarchical levels (for example, by double clicking a particular component or otherwise indicating a desire to do so) or navigate upward to analyze component relationships and associated security risk data. As an aggregated component can be graphically resolved to visualize associated sub-components, associated security risk percentage values become more understandable and an analysis to figure out a primary issue becomes reasonable to perform.

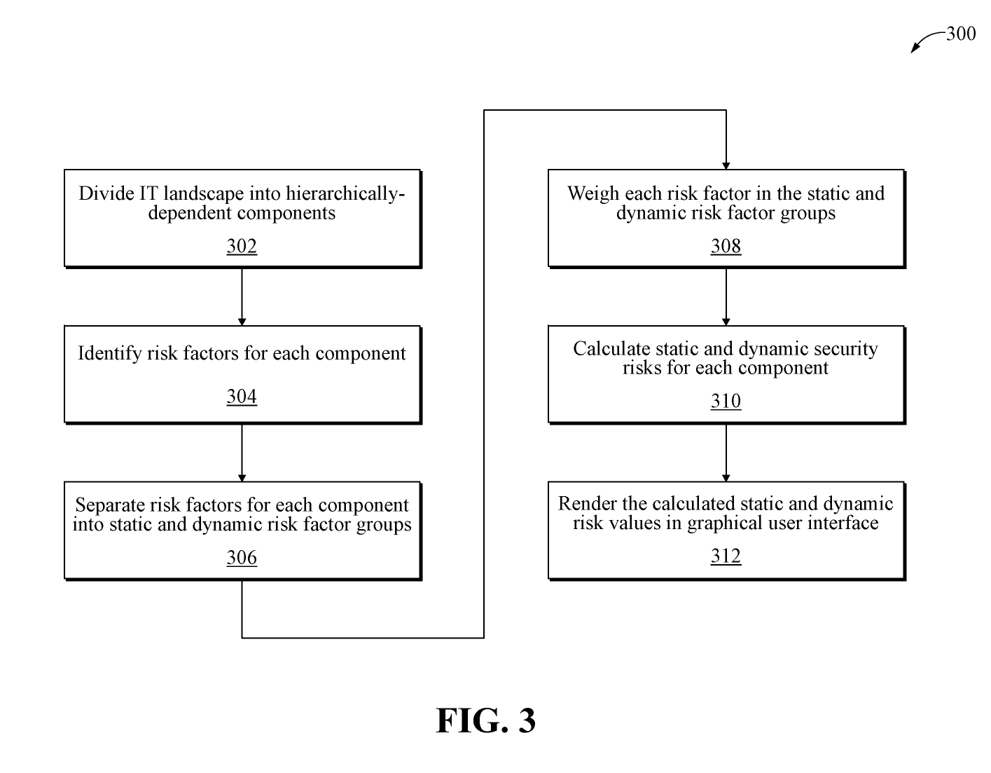

FIG. 3 is a flowchart of an example method 300 for calculation and visualization of security risks in ETD, according to an implementation. For clarity of presentation, the description that follows generally describes method 300 in the context of the other figures in this description. However, it will be understood that method 300 may be performed, for example, by any suitable system, environment, software, and hardware, or a combination of systems, environments, software, and hardware, as appropriate. In some implementations, various steps of method 300 can be run in parallel, in combination, in loops, or in any order.

At 302, an IT computing landscape is divided into hierarchically-dependent components. From 302, method 300 proceeds to 304.

At 304, relevant risk factors for each component are identified. A particular component can share risk factors with other components (for example, the system role “Productive”) and also have a subset of risk factors applicable to that particular component (for example, sub-component 204 could be an ABAP server running a WINDOWS operating system, sub-component 206 a JAVA server running a LINUX operating system, and 208 a database running in a clustering environment. There are some WINDOWS-only specific risks (for example, particular malware that targets WINDOWS systems) and ABAP-specific risks (for example, Remote Function Modules). The JAVA server could reside in a cloud computing environment (for example, AMAZON CLOUD SERVICES) that introduces particular cloud computing risk factors with completely different security components (for example, provided by the AMAZON hosting platform). The database could contain a cluster of computing nodes and archiving based on APACHE HADOOP to allow access to unlimited (but slow) data amounts. Thus, some risk factors could be the shared while others can be unique to different components.

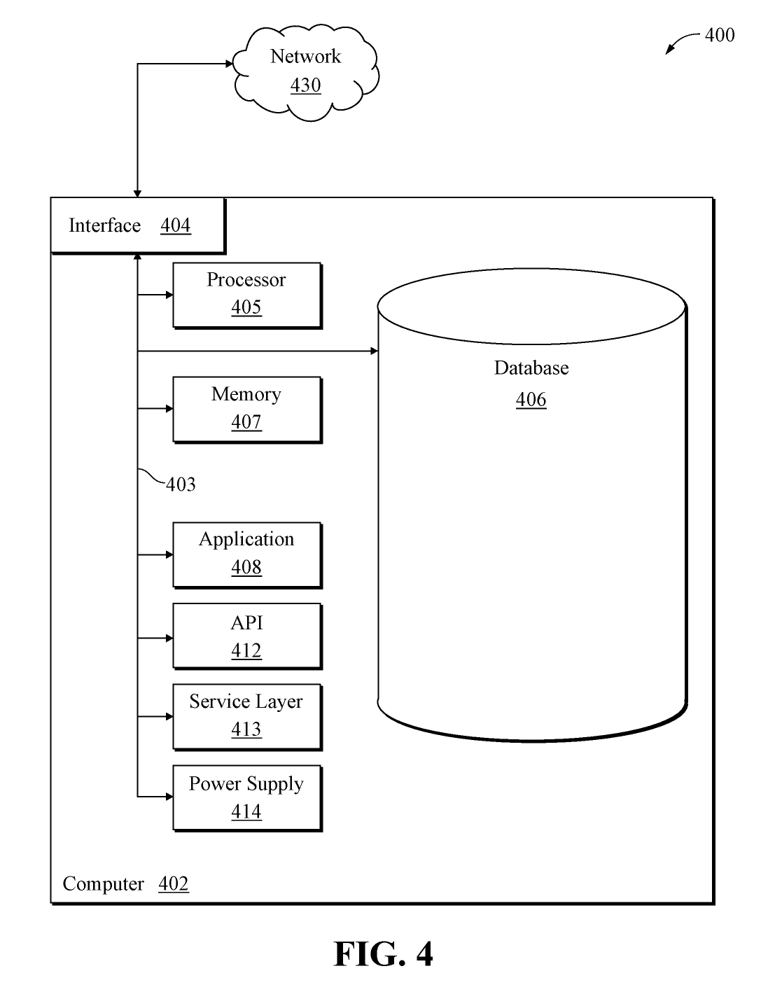

The knowledge of which risk-factors are applicable to a particular (sub-) component is typically stored either in a risk factor knowledge base (for example, a database) or hard-coded within a (sub-) component or other part of an overall computing system (for example, see FIG. 4), or other data storage location. Using the previously-described machine learning technologies, some risk factors applicable to a (sub-) component can be dynamically determined and applied (for example, dynamically or manually) to a (sub-) component at different points in time. In this way, the overall methodology can self-improve by updating applicable risk factors to enhance the sensitivity of the methodology. From 304, method 300 proceeds to 306.

At 306, the identified relevant risk factors are separated into dynamic and static risk factor groups for each component. In some implementations, the groups can be stored in the previously-described risk factor knowledge base, hard coded within a (sub-) component or other part of an overall computing system (for example, see FIG. 4), or other data storage location. From 306, method 300 proceeds to 308.

At 308, the weight of each risk factor in the determined dynamic and static groups is determined for each component. In some implementations, how each factor contributes to the associated static or dynamic risk depends mostly on the environment. For example, in a cloud provider company, the high availability of a platform plays extremely heavy role, where in an automotive company, access to an Intranet would be rated to a lower risk value. The determined weight value can be represented by any value that can be used to distinguish a range of weight values (for example, 0.0 is the lowest weight value, 0.1 is of a lower weight value than 0.8, and 1.0 is the highest weight).

At 310, for each component, a static and dynamic security risk is calculated using the static and dynamic risk factors, respectively. In typical implementations, the static and dynamic security risks are calculated in percentages. As an example of calculating static risk, assume an IT computing landscape (having the role of a component) consists of multiple computing systems (having the role of a subcomponent), and calculating the static risk for each single computing system and for the system landscape as a whole is desired. Also assume, static risk factors confidentiality risk, integrity risk, availability risk are to be considered. To calculate a static risk of a specific single computing system based on these three risk factors, one can multiply each determined risk factor weight with the computing system's (component's) risk factor value, sum the products, and normalize the sum to obtain a static risk value for the component between 0 and 100 percent. The static risk for the system landscape component (higher hierarchical level) is then calculated according to Equation (1), using the calculated static risks of the single systems. Calculation of the dynamic risk values is performed similarly.

As an example:
Assume the IT computing landscape L consists of two computing systems A and B. A is a test computing system, B is a productive computing system.
For testing purposes, productive data is copied from computing system B to computing system A.
A user sets values of the risk factors for each computing system, for example:
   a. Confidentiality A: risk value 100%, as A contains productive data.
   b. Integrity A: risk value 50%, as tests could be distorted.
   c. Availability A: risk value 10%: tests can be postponed.
   d. Confidentiality B: risk value 100%: productive data.
   e. Integrity A: risk value 100%: productive data.
   f. Availability A: risk value 90%: business downtime.
Static risk for L is calculated using Equation (1).
Weights within the IT computing landscape L for Confidentiality, Integrity, and Availability could be (for example, 33.33% each or 50%, 25%, 25%, respectively, in case confidentiality of the computing systems is rated more importantly. In typical implementations, all risk factors are weighted equally with no option for custom settings. In other implementations, risk factor weightings can vary or be customized.
Resulting risk values:

System A:
a) 1/3*100%+1/3*50%+1/3*10% 53.33%, or
b) 1/2*100%+1/4*50%+1/4*10% 65%.

System B:
a) 1/3*100%+1/3*100%+1/3*90% 96.66%, or
b) 1/2*100%+1/4*100%+1/4*90% 97.5%.

In some implementations, method 300 could also include a separate step (for example, 309 between 308 and 310) to make settings for the computing systems as described in the foregoing example.

In some implementations, machine learning technologies can be used to decide (for example, using stored statistical data) what is considered “normal” behavior for a particular risk factor in relation to a particular component. The machine learning technologies can help to improve efficiency in calculations by selecting calculation formulas (for example, in place of or to use in conjunction with Equation (1) or for other calculations consistent with the described subject matter) based on available data and adjusting calculation formulas over time given additional data. Additionally, the machine learning technologies can be used to define types and levels of risk thresholds used for static and dynamic risk factor weighting based on past static and dynamic risk value determinations. The machine learning technologies can also take into account comparisons/correlations between static and dynamic risk value determinations given particular determined static/dynamic risk factors and groups to make adjustments to any data used in the described methodology, raise alerts, or for any other purpose consistent with this disclosure. From 310, method 300 proceeds to 312.

At 312, the static and dynamic security risk values for each component are rendered in the graphical user interface for analysis. After 312, method 300 stops.

FIG. 4 is a block diagram of an example computer system 400 used to provide computational functionalities associated with described algorithms, methods, functions, processes, flows, and procedures, as described in the instant disclosure, according to an implementation. The illustrated computer 402 is intended to encompass any computing device such as a server, desktop computer, laptop/notebook computer, wireless data port, smart phone, personal data assistant (PDA), tablet computing device, one or more processors within these devices, or any other suitable processing device, including physical or virtual instances (or both) of the computing device. Additionally, the computer 402 may comprise a computer that includes an input device, such as a keypad, keyboard, touch screen, or other device that can accept user information, and an output device that conveys information associated with the operation of the computer 402, including digital data, visual, or audio information (or a combination of information), or a graphical user interface (GUI).

The computer 402 can serve in a role as a client, network component, a server, a database or other persistency, or any other component (or a combination of roles) of a computer system for performing the subject matter described in the instant disclosure. The illustrated computer 402 is communicably coupled with a network 430. In some implementations, one or more components of the computer 402 may be configured to operate within environments, including cloud-computing-based, local, global, or other environment (or a combination of environments).

At a high level, the computer 402 is an electronic computing device operable to receive, transmit, process, store, or manage data and information associated with the described subject matter. According to some implementations, the computer 402 may also include or be communicably coupled with an application server, e-mail server, web server, caching server, streaming data server, or other server (or a combination of servers).

The computer 402 can receive requests over network 430 from a client application (for example, executing on another computer 402) and respond to the received requests by processing the received requests using an appropriate software application(s). In addition, requests may also be sent to the computer 402 from internal users (for example, from a command console or by other appropriate access method), external or third-parties, other automated applications, as well as any other appropriate entities, individuals, systems, or computers.

Each of the components of the computer 402 can communicate using a system bus 403. In some implementations, any or all of the components of the computer 402, hardware or software (or a combination of both hardware and software), may interface with each other or the interface 404 (or a combination of both), over the system bus 403 using an application programming interface (API) 412 or a service layer 413 (or a combination of the API 412 and service layer 413). The API 412 may include specifications for routines, data structures, and object classes. The API 412 may be either computer-language independent or dependent and refer to a complete interface, a single function, or even a set of APIs. The service layer 413 provides software services to the computer 402 or other components (whether or not illustrated) that are communicably coupled to the computer 402. The functionality of the computer 402 may be accessible for all service consumers using this service layer. Software services, such as those provided by the service layer 413, provide reusable, defined functionalities through a defined interface. For example, the interface may be software written in JAVA, C++, or other suitable language providing data in extensible markup language (XML) format or other suitable format. While illustrated as an integrated component of the computer 402, alternative implementations may illustrate the API 412 or the service layer 413 as stand-alone components in relation to other components of the computer 402 or other components (whether or not illustrated) that are communicably coupled to the computer 402. Moreover, any or all parts of the API 412 or the service layer 413 may be implemented as child or sub-modules of another software module, enterprise application, or hardware module without departing from the scope of this disclosure.

The computer 402 includes an interface 404. Although illustrated as a single interface 404 in FIG. 4, two or more interfaces 404 may be used according to particular needs, desires, or particular implementations of the computer 402. The interface 404 is used by the computer 402 for communicating with other systems that are connected to the network 430 (whether illustrated or not) in a distributed environment. Generally, the interface 404 comprises logic encoded in software or hardware (or a combination of software and hardware) and is operable to communicate with the network 430. More specifically, the interface 404 may comprise software supporting one or more communication protocols associated with communications such that the network 430 or interface's hardware is operable to communicate physical signals within and outside of the illustrated computer 402.

The computer 402 includes a processor 405. Although illustrated as a single processor 405 in FIG. 4, two or more processors may be used according to particular needs, desires, or particular implementations of the computer 402. Generally, the processor 405 executes instructions and manipulates data to perform the operations of the computer 402 and any algorithms, methods, functions, processes, flows, and procedures as described in the instant disclosure.

The computer 402 also includes a database 406 that can hold data for the computer 402 or other components (or a combination of both) that can be connected to the network 430 (whether illustrated or not). For example, database 406 can be an in-memory, conventional, or other type of database storing data consistent with this disclosure. In some implementations, database 406 can be a combination of two or more different database types (for example, a hybrid in-memory and conventional database) according to particular needs, desires, or particular implementations of the computer 402 and the described functionality. Although illustrated as a single database 406 in FIG. 4, two or more databases (of the same or combination of types) can be used according to particular needs, desires, or particular implementations of the computer 402 and the described functionality. While database 406 is illustrated as an integral component of the computer 402, in alternative implementations, database 406 can be external to the computer 402.

The computer 402 also includes a memory 407 that can hold data for the computer 402 or other components (or a combination of both) that can be connected to the network 430 (whether illustrated or not). For example, memory 407 can be random access memory (RAM), read-only memory (ROM), optical, magnetic, and the like, storing data consistent with this disclosure. In some implementations, memory 407 can be a combination of two or more different types of memory (for example, a combination of RAM and magnetic storage) according to particular needs, desires, or particular implementations of the computer 402 and the described functionality. Although illustrated as a single memory 407 in FIG. 4, two or more memories 407 (of the same or combination of types) can be used according to particular needs, desires, or particular implementations of the computer 402 and the described functionality. While memory 407 is illustrated as an integral component of the computer 402, in alternative implementations, memory 407 can be external to the computer 402.

The application 408 is an algorithmic software engine providing functionality according to particular needs, desires, or particular implementations of the computer 402, particularly with respect to functionality described in this disclosure. For example, application 408 can serve as one or more components, modules, or applications. Further, although illustrated as a single application 408, the application 408 may be implemented as multiple applications 408 on the computer 402. In addition, although illustrated as integral to the computer 402, in alternative implementations, the application 408 can be external to the computer 402.

The computer 402 can also include a power supply 414. The power supply 414 can include a rechargeable or non-rechargeable battery that can be configured to be either user- or non-user-replaceable. In some implementations, the power supply 414 can include power-conversion or management circuits (including recharging, standby, or other power management functionality). In some implementations, the power-supply 414 can include a power plug to allow the computer 402 to be plugged into a wall socket or other power source to, for example, power the computer 402 or recharge a rechargeable battery.

There may be any number of computers 402 associated with, or external to, a computer system containing computer 402, each computer 402 communicating over network 430. Further, the term “client,” “user,” and other appropriate terminology may be used interchangeably, as appropriate, without departing from the scope of this disclosure. Moreover, this disclosure contemplates that many users may use one computer 402, or that one user may use multiple computers 402.

Described implementations of the subject matter can include one or more features, alone or in combination.

For example, in a first implementation, a computer-implemented method, comprising: dividing up an information technology computing landscape into hierarchically-dependent components; identifying relevant risk factors for each component; separating the identified relevant risk factors for each component into static and dynamic risk factor groups; determining the weight of each risk factor in the static and dynamic risk factor groups for each component; and calculating static and dynamic security risks for each component.

The foregoing and other described implementations can each, optionally, include one or more of the following features:

A first feature, combinable with any of the following features, wherein division of the information technology computing landscape is performed in a step-wise manner, where the components are associated with risk properties including assignment of a security rating, seen as a target for an attack, or seen as a unit with a potential security improvement.

A second feature, combinable with any of the previous or following features, wherein a particular component is considered to be at a lowest hierarchical level when the particular component cannot be seen as an aggregation of at least one component at a hierarchically lower level with at least one risk property.

A third feature, combinable with any of the previous or following features, wherein sorting or filtering of the components can be performed in an ascending or descending manner.

A fourth feature, combinable with any of the previous or following features, wherein the risk factor groups are stored in a knowledge base or hard-coded within one or more components.

A fifth feature, combinable with any of the previous or following features, wherein the static and dynamic risk factors for each particular component are calculated by multiplying each static or dynamic risk factor weight value with the particular component's risk factor value, summing the products, and normalizing the sum of the products.

A sixth feature, combinable with any of the previous or following features, further comprising using machine learning technologies to weight static and dynamic risk factors based on prior static and dynamic risk value determinations.

In a second implementation, a non-transitory, computer-readable medium storing one or more instructions executable by a computer system to perform operations comprising: dividing up an information technology computing landscape into hierarchically-dependent components; identifying relevant risk factors for each component; separating the identified relevant risk factors for each component into static and dynamic risk factor groups; determining the weight of each risk factor in the static and dynamic risk factor groups for each component; and calculating static and dynamic security risks for each component.

The foregoing and other described implementations can each, optionally, include one or more of the following features:

A first feature, combinable with any of the following features, wherein division of the information technology computing landscape is performed in a step-wise manner, where the components are associated with risk properties including assignment of a security rating, seen as a target for an attack, or seen as a unit with a potential security improvement.

A second feature, combinable with any of the previous or following features, wherein a particular component is considered to be at a lowest hierarchical level when the particular component cannot be seen as an aggregation of at least one component at a hierarchically lower level with at least one risk property.

A third feature, combinable with any of the previous or following features, wherein sorting or filtering of the components can be performed in an ascending or descending manner.

A fourth feature, combinable with any of the previous or following features, wherein the risk factor groups are stored in a knowledge base or hard-coded within one or more components.

A fifth feature, combinable with any of the previous or following features, wherein the static and dynamic risk factors for each particular component are calculated by multiplying each static or dynamic risk factor weight value with the particular component's risk factor value, summing the products, and normalizing the sum of the products.

A sixth feature, combinable with any of the previous or following features, further comprising one or more instructions to use machine learning technologies to weight static and dynamic risk factors based on prior static and dynamic risk value determinations.

In a third implementation, a computer-implemented system, comprising: a computer memory; and a hardware processor interoperably coupled with the computer memory and configured to perform operations comprising: dividing up an information technology computing landscape into hierarchically-dependent components; identifying relevant risk factors for each component; separating the identified relevant risk factors for each component into static and dynamic risk factor groups; determining the weight of each risk factor in the static and dynamic risk factor groups for each component; and calculating static and dynamic security risks for each component.

The foregoing and other described implementations can each, optionally, include one or more of the following features:

A first feature, combinable with any of the following features, wherein division of the information technology computing landscape is performed in a step-wise manner, where the components are associated with risk properties including assignment of a security rating, seen as a target for an attack, or seen as a unit with a potential security improvement.

A second feature, combinable with any of the previous or following features, wherein a particular component is considered to be at a lowest hierarchical level when the particular component cannot be seen as an aggregation of at least one component at a hierarchically lower level with at least one risk property.

A third feature, combinable with any of the previous or following features, wherein sorting or filtering of the components can be performed in an ascending or descending manner.

A fourth feature, combinable with any of the previous or following features, wherein the risk factor groups are stored in a knowledge base or hard-coded within one or more components.

A fifth feature, combinable with any of the previous or following features, wherein the static and dynamic risk factors for each particular component are calculated by multiplying each static or dynamic risk factor weight value with the particular component's risk factor value, summing the products, and normalizing the sum of the products.

A sixth feature, combinable with any of the previous or following features, further configured to use machine learning technologies to weight static and dynamic risk factors based on prior static and dynamic risk value determinations.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data may be less than 1 ms, less than 1 sec., or less than 5 secs. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS, or any other suitable conventional operating system.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components, as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM), or both. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data includes all forms of non-volatile memory, media and memory devices, including by way of example semiconductor memory devices, for example, erasable programmable read-only memory (EPROM), electrically erasable programmable read-only memory (EEPROM), and flash memory devices; magnetic disks, for example, internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain this disclosure. Other changes, substitutions, and alterations are also possible without departing from the spirit and scope of this disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
dividing up an information technology computing landscape into hierarchically-dependent components;
identifying relevant risk factors for each component;
separating the identified relevant risk factors for each component into static and dynamic risk factor groups;
determining the weight of each risk factor in the static and dynamic risk factor groups for each component; and
calculating static and dynamic security risks for each component.

2. The computer-implemented method of claim 1, wherein division of the information technology computing landscape is performed in a step-wise manner, where the components are associated with risk properties including assignment of a security rating, seen as a target for an attack, or seen as a unit with a potential security improvement.

3. The computer-implemented method of claim 2, wherein a particular component is considered to be at a lowest hierarchical level when the particular component cannot be seen as an aggregation of at least one component at a hierarchically lower level with at least one risk property.

4. The computer-implemented method of claim 1, wherein sorting or filtering of the components can be performed in an ascending or descending manner.

5. The computer-implemented method of claim 1, wherein the risk factor groups are stored in a knowledge base or hard-coded within one or more components.

6. The computer-implemented method of claim 1, wherein the static and dynamic risk factors for each particular component are calculated by multiplying each static or dynamic risk factor weight value with the particular component's risk factor value, summing the products, and normalizing the sum of the products.

7. The computer-implemented method of claim 1, further comprising using machine learning technologies to weight static and dynamic risk factors based on prior static and dynamic risk value determinations.

8. A non-transitory, computer-readable medium storing one or more instructions executable by a computer system to perform operations comprising:
dividing up an information technology computing landscape into hierarchically-dependent components;
identifying relevant risk factors for each component;
separating the identified relevant risk factors for each component into static and dynamic risk factor groups;
determining the weight of each risk factor in the static and dynamic risk factor groups for each component; and
calculating static and dynamic security risks for each component.

9. The non-transitory, computer-readable medium of claim 8, wherein division of the information technology computing landscape is performed in a step-wise manner, where the components are associated with risk properties including assignment of a security rating, seen as a target for an attack, or seen as a unit with a potential security improvement.

10. The non-transitory, computer-readable medium of claim 9, wherein a particular component is considered to be at a lowest hierarchical level when the particular component cannot be seen as an aggregation of at least one component at a hierarchically lower level with at least one risk property.

11. The non-transitory, computer-readable medium of claim 8, wherein sorting or filtering of the components can be performed in an ascending or descending manner.

12. The non-transitory, computer-readable medium of claim 8, wherein the risk factor groups are stored in a knowledge base or hard-coded within one or more components.

13. The non-transitory, computer-readable medium of claim 8, wherein the static and dynamic risk factors for each particular component are calculated by multiplying each static or dynamic risk factor weight value with the particular component's risk factor value, summing the products, and normalizing the sum of the products.

14. The non-transitory, computer-readable medium of claim 8, further comprising one or more instructions to use machine learning technologies to weight static and dynamic risk factors based on prior static and dynamic risk value determinations.

15. A computer-implemented system, comprising:
a computer memory; and
a hardware processor interoperably coupled with the computer memory and configured to perform operations comprising:
dividing up an information technology computing landscape into hierarchically-dependent components;
identifying relevant risk factors for each component;
separating the identified relevant risk factors for each component into static and dynamic risk factor groups;
determining the weight of each risk factor in the static and dynamic risk factor groups for each component; and
calculating static and dynamic security risks for each component.

16. The computer-implemented system of claim 15, wherein division of the information technology computing landscape is performed in a step-wise manner, where the components are associated with risk properties including assignment of a security rating, seen as a target for an attack, or seen as a unit with a potential security improvement, and wherein a particular component is considered to be at a lowest hierarchical level when the particular component cannot be seen as an aggregation of at least one component at a hierarchically lower level with at least one risk property.

17. The computer-implemented system of claim 15, wherein sorting or filtering of the components can be performed in an ascending or descending manner.

18. The computer-implemented system of claim 15, wherein the risk factor groups are stored in a knowledge base or hard-coded within one or more components.

19. The computer-implemented system of claim 15, wherein the static and dynamic risk factors for each particular component are calculated by multiplying each static or dynamic risk factor weight value with the particular component's risk factor value, summing the products, and normalizing the sum of the products.

20. The computer-implemented system of claim 15, further configured to use machine learning technologies to weight static and dynamic risk factors based on prior static and dynamic risk value determinations.
